(19) United States
(12) Patent Application Publication
(10) Pub. No.: US 2025/0383903 A1
(43) Pub. Date: Dec. 18, 2025

(54) DISTRIBUTED KEY-VALUE STORE-BASED MANAGEMENT OF VIRTUAL MACHINE AVAILABILITY

(71) Applicant: HEWLETT PACKARD ENTERPRISE DEVELOPMENT LP, Spring, TX (US)

(72) Inventors: Charles F. Tuffli, Roseville, CA (US); Eric P. Forgette, Clarence, NY (US); Steven R. Lahr, Roseville, CA (US); Nicholas E. Phillips, Roseville, CA (US); Michael F. Carlin, Roseville, CA (US)

(21) Appl. No.: 18/743,611

(22) Filed: Jun. 14, 2024

(51) Int. Cl. G06F 9/455

(52) U.S. Cl. CPC G06F 9/45558

(57) ABSTRACT

Availability of a virtual machine is managed using a distributed key-value store. The distributed key-value store includes a first entry and a second entry. The first entry represents a definition of the virtual machine, and the second entry represents that a first node of the cluster hosts the virtual machine. Managing availability of the virtual machine includes detecting unavailability of the virtual machine. Managing availability of the virtual machine includes, responsive to detecting unavailability of the virtual machine, writing a task entry to the distributed key-value store to cause a second node of the cluster to create the virtual machine on the second node. Managing availability of the virtual machine includes rewriting the second entry so that the second entry represents that the second node hosts the virtual machine.

### BACKGROUND

A distributed system has resources that are located in multiple computer nodes (e.g., servers). A cluster, a type of distributed system, includes a collection of nodes that coordinate their processing activities to achieve a common goal.

### BRIEF DESCRIPTION OF THE DRAWINGS

FIG. 1 is a block diagram of a cluster computing system that includes on-premise nodes that use a distributed key-value store to manage virtual machine high availability according to an example implementation.

FIG. 2 is a flow diagram depicting a technique to manage virtual machine high availability according to an example implementation.

FIG. 3 is a sequence flow diagram illustrating actions taken by nodes of a cluster responsive to a cloud-based control plane assigning a virtual machine, according to an example implementation.

FIG. 4 is a sequence flow diagram illustrating actions taken by leader and surviving nodes of a cluster responsive to another node of the cluster becoming unavailable, according to an example implementation.

FIG. 5 is a block diagram of a virtual machine high availability daemon according to an example implementation.

FIG. 6 is a block diagram of a node that detects and responds to a virtual machine being unavailable, according to an example implementation.

FIG. 7 is a flow diagram depicting a technique to create a virtual machine on a node and update a distributed key-value store to represent that the virtual machine is hosted on the node, according to an example implementation.

FIG. 8 is an illustration of a non-transitory storage medium that stores machine-readable instructions that, when executed by a machine, cause the machine to update a distributed key-value store responsive to an assignment of a virtual machine to a node of a cluster, according to an example implementation.

### DETAILED DESCRIPTION

A high availability (HA) system includes features that avoid single points-of-failure so that the system remains available even if failures occur. A cluster computing system may have clusters of nodes (e.g., servers) that host virtual machines (VMs). The clusters may correspond to respective VM HA domains. VMs may temporarily be unavailable for different reasons. In an example, a VM may become unavailable due to the VM unexpectedly stopping (e.g., a VM stopped without a user powering off the VM). In another example, a VM may experience temporary unavailability due to its host node experiencing a failure. In another example, a VM may temporarily be unavailable due to a supporting infrastructure (e.g., a power grid or a network) for the host node experiencing an outage.

As part of providing VM HA, a cluster computing system may detect when a node becomes unavailable, and in what may also be referred to as VM “failover,” the cluster computing system may relocate the VMs that are hosted by the node to one or multiple surviving nodes. As also part of providing VM HA, a cluster computing system may detect when a VM on an available host node unexpectedly stops, and the cluster computing system may restart the VM.

In one approach, a control plane of a cluster computing system may manage VM HA. In this context, a “control plane” of a cluster computing system refers to an infrastructure that orchestrates and manages the computing system. A control plane may perform a number of functions other than managing VM HA, such as detecting nodes, grouping nodes into clusters, provisioning nodes, assigning VMs to nodes, scaling up and down the nodes of a cluster to accommodate workload demands, as well as other functions.

For such reasons as flexibility and convenience, a business entity may choose to use a cloud-based control plane for the entity's cluster computing system. In an example, a cloud-based control plane may be a public cloud “as-a-service” that is provided by a service provider, which provides and manages cloud services over the Internet to customers of the cloud service provider. Although a business entity may select a cloud-based control plane for its cluster computing system, the business entity may decide to keep some original equipment of the cluster computing system out of the public cloud. For example, for such reasons as physical security protection, accessibility and cost management, a business entity may choose to keep nodes, storage arrays and associated local networking equipment of its cluster computing system on-site. In this context, equipment being “on-site” (or “on-premise”) refers to the equipment being located on physical property that is owned and controlled by the business entity. In an example, a business entity may keep nodes, storage arrays and associated local networking equipment of its cluster computing system in the entity's private datacenter. In another example, cluster computing system equipment may be located in leased space of a colocation datacenter. Therefore, a cluster computing system solution for a business entity may be one in which the cluster computing system's control plane is cloud-based, and certain components of the cluster computing system, such as the nodes, are located on-premise.

Cloud-based services may potentially be unavailable at times due to any of a number of reasons, such as network failures, security attacks, power outages, natural disasters, or other causes. Accordingly, a cloud-based control plane may potentially be temporarily unavailable. If the cloud-based control plane manages VM HA for a cluster computing system, then VM HA may be lost when the control plane is unavailable.

In accordance with example implementations that are described herein, a cluster computing system includes a cloud-based control plane and on-premise nodes. The on-premise nodes manage VM HA using a distributed key-value store (or “DKVS”). The management of the VM HA is independent from the cloud-based control plane. Therefore, VM HA is provided, even for times in which the cloud-based control plane is unavailable.

More specifically, in accordance with example implementations, a cluster computing system may include one or multiple clusters. Each cluster includes a collection of nodes and corresponds to a VM HA domain, and VM HA-related information about the cluster is stored in a distributed key-value store. In accordance with example implementations, for each cluster, the member nodes of the cluster coordinate to elect a node, called the “leader node,” to monitor the liveliness of the other nodes and initiate appropriate actions (e.g., actions related to restarting VMs and relocating VMs) to maintain VM HA. The remaining member nodes (other than the elected, leader node) of the cluster are referred to herein as the “follower nodes.” In accordance with example implementations, the distributed key-value store includes such VM HA-related information as cluster membership, VM locations and VM definitions.

In the context used herein, a “distributed store” generally refers to a collection of data that is hosted as multiple replicas on respective nodes of a cluster. The replicas are consistent, which means that the replicas are the same due to a certain protocol involving messaging and logging by the nodes. A “key-value store,” in the context used herein, refers to a collection of data having entries that are identified by unique labels, called “keys.” In an example, a particular entry of a key-value store may contain a key and associated data (the “value”). In another example, a particular entry of a key-value store may solely contain a key (e.g., a topology key, as further described herein) and no value. A distributed key-value store provides fault tolerance in that the integrity of the distributed key-value store is unaffected by a node of the cluster becoming unavailable.

In accordance with example implementations, for each VM of a cluster, the distributed key-value store includes two entries related to managing VM HA: a VM definition entry and a VM topology entry. The VM definition entry specifies, or represents, a definition for a specific VM, such as configuration and resource attributes of the VM. More specifically, in accordance with example implementations, the VM definition entry includes a key (called an “object definition key” herein) that associates the key with an object definition, identifies the object as being a VM, and contains an identifier (e.g., a universally unique identifier (UUID)) that identifies a specific VM. The VM definition entry further includes a value (e.g., a JAVASCRIPT Object Notation (JSON) serialized representation) that represents the VM definition.

The VM topology entry includes a key (called a “topology key” herein) that associates the key with a topology, identifies the topology as corresponding to a VM, contains an identifier (e.g., a UUID) that identifies the cluster, contains an identifier (e.g., a UUID) that identifies the node that hosts the VM, and contains an identifier (e.g., a UUID) that identifies the VM. The VM topology entry therefore identifies a node location for the VM, i.e., identifies the node that hosts the VM. In accordance with example implementations, the second entry does not contain a value, as the topology key by itself identifies the VM's node location. The topology key of a VM topology entry is referred to as a “VM topology key” herein.

The leader node, upon detecting that a node of the cluster is unavailable, begins a VM failover sequence to relocate the VMs that were hosted by the unavailable node to one or multiple surviving nodes. More specifically, pursuant to the VM failover sequence, the leader node retrieves, from the distributed key-value store, VM topology keys that correspond to the unavailable node. From the retrieved topology keys, the leader node identifies the VMs that were hosted by the unavailable node. The leader node may then select one or multiple surviving nodes of the cluster to host the identified VMs (also referred to herein as the “relocated” VMs or “affected” VMs).

The next part of the VM failover sequence involves the leader node initiating, or triggering, tasks on the selected surviving node(s) to create the relocated VMs on the selected surviving node(s). For this purpose, in accordance with example implementations, the leader node writes key-value entries (called “task submission key-value entries” herein) to the distributed key-value store. In accordance with example implementations, each task submission key-value entry corresponds to a particular re-located VM and corresponds to a “create VM task,” a node-level task, to create the VM. The task submission key-value entry includes a key (called a “task submission key” herein). The task submission key represents the submission of a task, identifies the task as being a node-level task, identifies a node to perform the task and assigns a task identifier (e.g., a UUID) for the task. Moreover, the task submission key-value entry has a value (e.g., a JSON serialized representation) that represents the node-level task (e.g., a node-level task to create a VM).

The next part of the VM failover sequence involves the targeted surviving node(s) responding to the task submission key-value entries for purposes of creating the relocated VMs. A node may recognize a task submission key-value entry that targets the node in a number of different ways. In an example, the recognition may be the result of the node watching the distributed key-value store for task submission keys that contain the node's identifier. Responsive to recognizing a task submission key being stored in the distributed key-value store, which identifies the surviving node, the surviving node retrieves the corresponding task submission key-value entry from the distributed key-value store. For purposes of VM failover, the retrieved task submission key-value has a value that represents a node-level task to create a VM. For example, the value may be a JSON serialized representation of a create VM task, and the node deserializes the representation to derive data that describes the create VM task. The surviving node then executes the VM create task to create the VM on the surviving node. The surviving node's execution of the create VM task includes the node retrieving the definition of the VM, i.e., retrieving the VM definition from the corresponding VM definition key-value entry in the distributed key-value store.

The last part of the VM failover sequence, in accordance with example implementations, involves the updating of the VM topology keys in the distributed key-value store. As part of or in association with the VM creation task, a surviving node rewrites the VM topology key for a VM to change the indicated node location of the VM from the unavailable node to the surviving node. In this context, “rewriting” a topology key generally refers to replacing a first topology key of the distributed key-value store with a second topology key. In an example, rewriting the VM topology key includes the surviving node taking actions to delete, from the distributed key-value store, a first VM topology key that indicates that the VM is hosted by the unavailable node and write, to the distributed key-value store, a second VM topology key that indicates that the VM is now hosted by the surviving node.

In accordance with example implementations, the nodes execute respective background programs, called “VM HA daemons” herein, for purposes of using the distributed key-value store to manage VM HA. As described further herein, the collection of VM HA daemons for a cluster includes an active, or leader, daemon (called the “leader VM HA daemon” herein), with the remaining daemons (called “follower VM HA daemons” herein) of the cluster being passive, or following directions from the leader. In the context that is used herein, the node hosting the leader VM HA daemon is referred to as the “leader node,” and each of the remaining member nodes of the cluster (which host respective follower VM HA daemons) are referred to as “follower nodes.” The member VM HA daemons of a cluster elect the leader. The leader/follower designation may change over time, as depending on such factors as node availability and election terms. The follower VM HA daemons provide heartbeats that are monitored by the leader VM HA daemon for purposes of monitoring the liveliness of the follower VM daemons and their associated host nodes and correspondingly detecting when a follower node becomes unavailable. In accordance with example implementations, the leader VM HA daemon and the follower VM HA daemons coordinate to perform the VM failover sequence described herein.

As can be appreciated, the VM HA solution accommodates a cluster computing system that includes on-premise nodes and a cloud-based control plane. The management of VM HA using the on-premise nodes and a distributed key-value store allows VM HA to be performed independently from the cloud-based control plane. Therefore, VM HA is unaffected by cloud service unavailability.

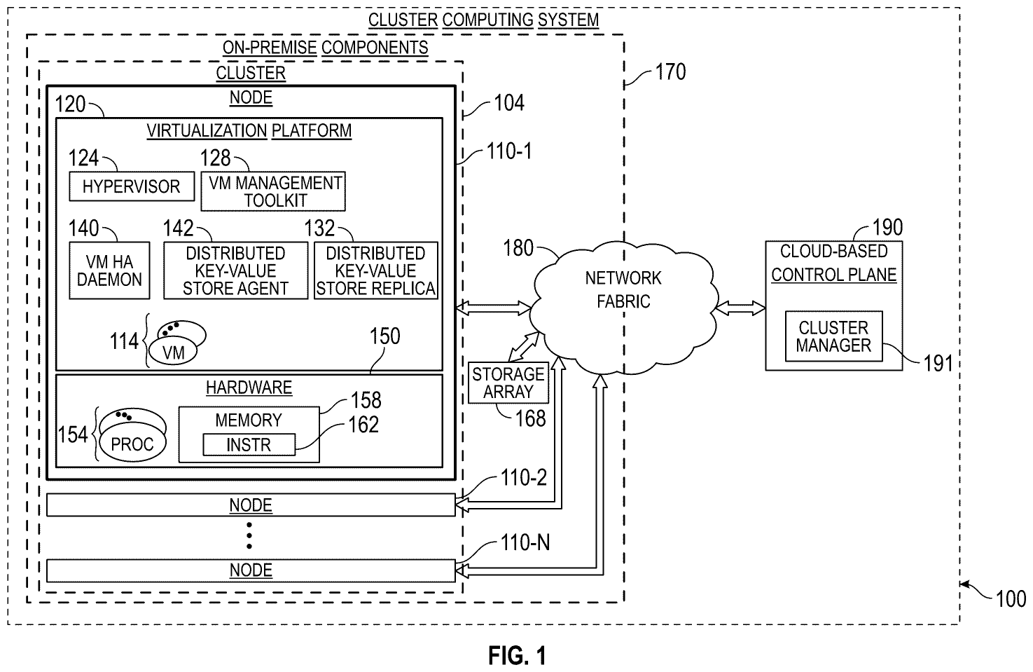

Referring to FIG. 1, as a more specific example, a cluster computing system 100 includes nodes 110 that may be grouped to form one or multiple clusters 104. In the context that is used herein, a “cluster” refers to a collection of nodes 110 within the same VM HA fault domain. Although FIG. 1 depicts N nodes 110-1, 110-2 to 110-N of a particular exemplary cluster 104, the cluster computing system 100 may include various clusters have different respective numbers of nodes 110. For example, one cluster 104 may have N nodes 110, another cluster 104 may have more than N nodes 110 and an additional cluster 104 may have less than N nodes 110. Moreover, the number of nodes of a given cluster 104 may vary over time for any of a number of different reasons, such as node availability and node scaling.

In examples, a node 110 may be a blade server, a rack server, a tower server or any other actual, or physical, processor-based platform. In another example, in accordance with further implementations, a node 110 may be a partition of a particular physical processor-based platform (e.g., CPU cores of a particular blade server are allocated to multiple nodes). FIG. 1 depicts specific components for node 110-1. Other nodes 110 of the cluster 104 may include components similar to the components of the node 110-1.

A node 110 may host, one or multiple VMs 114. In the context used herein, a “VM” (also called a “virtual machine,” a “guest VM,” a “VM instance,” or a “guest VM instance”), such as the VM 114, refers to a virtual environment that functions as a machine-level abstraction, or virtual computer system, which has its own resources (e.g., one or multiple CPUs, a system memory, one or multiple network interfaces and one or multiple storage devices). The VM 114 has its own abstraction of an operating system; and in general, the VM 114 is a virtual abstraction of hardware and software resources of the node 110. A hypervisor 124 of the node 110 controls the lifecycle (e.g., the deployment, starting and stopping) of a VM 114 that is hosted by the node 110.

The hypervisor 124 is part of a virtualization platform 120 of the node 110. The hypervisor 124, in accordance with some implementations, is a bare metal, or Type 1, hypervisor that runs directly on hardware 150 of the node 110. In an example, the hypervisor 124 may be part of the kernel of an operating system and turn the operating system into a Type 1 hypervisor. In an example, the operating system may be a LINUX operating system, and the hypervisor 124 may be a kernel VM (KVM). In other examples, the hypervisor 124 may be a VMWARE SPHERE hypervisor, a WINDOWS HYPER-V hypervisor, a XEN hypervisor or other Type 1 hypervisor. In other examples, the hypervisor 124 may be a VMWARE WORKSTATION hypervisor, an ORACLE VIRTUALBOX hypervisor or other Type 2 hypervisor that runs on top of an operating system.

The virtualization platform 120 may also include one or multiple programs and libraries of a virtualization management toolkit 128. The virtualization management toolkit 128, in accordance with example implementations, may include a daemon and provide APIs that interact with the hypervisor 124 for purposes for managing the lifecycles of VMs 114. In examples, the virtualization management toolkit 128 may provide APIs for commands to perform VM lifecycle-related functions, such as VM provisioning, VM creation, VM starting (e.g., guest operating system starting), VM stopping (e.g., guest operating system stopping) and VM monitoring. In an example, the virtualization management toolkit 128 may be a libvirt package.

In accordance with example implementations, the cluster computing system 100 may be affiliated with an entity (e.g., a business organization) that chooses to construct the system 100 from on-premise components 170 and a cloud-based control plane 190, as depicted in FIG. 1. The on-premise components 170 are located on physical property (e.g., one or multiple private datacenters and/or one or multiple co-location datacenters) owned or leased by the entity. As depicted in FIG. 1, in addition to the nodes 110, the on-premise components 170 may include one or multiple storage arrays 168 that are shared by the nodes 110 and further include network components of network fabric 180. The on-premise components 170, in accordance with example implementations, may correspond to a private network, which interconnects the on-premise components 170.

The network fabric 180, in general, interconnects the on-premise components 170 and connects the nodes 110 to a wide area network (or “WAN,” such as the Internet) that includes the cloud-based control plane 190. In general, the network fabric 180 may be associated with one or multiple types of communication networks, such as (as examples) Fibre Channel networks, Compute Express Link (CXL) fabric, dedicated management networks, local area networks (LANs), WANs, wireless networks, or any combination thereof.

Although not depicted in FIG. 1, one or multiple client nodes may be connected to the nodes 110 via the network fabric 180. The client nodes may, for example, provide graphical user interfaces (GUIs) and interact with the nodes 110 using application programming interfaces (APIs) for any of a number of purposes. In examples, via client nodes, users may perform administrative functions on the cluster computing system 100 and configure the cluster computing system 100. In another example, via the client nodes, users may interact with the cloud-based control plane 190 to set up and initiate the deployment of VMs 114 to nodes 110. In another example, via the client nodes, users may interact with the cloud-based control plane 190 to consume applications and services provided by VMs 114 that are hosted by the nodes 110. In another example, via client nodes, users may start and stop the VMs 114. In another example, via a client node, a user may configure the cloud-based control plane 190. In examples, the client nodes may take on one of many different forms, such as laptop computers, tablet computers, smartphones, desktop computers, blade servers, tower servers, wearable computers, rack servers, or other processor-based platforms.

As depicted in FIG. 1, in accordance with example implementations, the cloud-based control plane 190 includes a cluster manager 191. In an example, the cluster manager 191 may be affiliated with a public “as-a-service” provided by a service provider, which provides and manages cloud services over the Internet. The cluster manager 191, in general, provides orchestration and management services for the cluster computing system 100. In an example, the services provided by the cluster manager 191 may include discovering nodes 110 and grouping collections of nodes 110 together into respective clusters 104. In another example, the services provided by the cluster manager 191 may include scaling up and down the number of nodes 110 of a particular cluster 104 to accommodate a workload demand. In another example, the services provided by the cluster manager 191 may include services to provision the nodes 110. In another example, the services provided by the cluster manager 191 may include services to manage networking devices or networking overlays. In another example, the services provided by the cluster manager 191 may include assigning VMs 114 to nodes 110. In another example, the services provided by the cluster manager 191 may include providing VM definitions.

In accordance with example implementations, VM HA for a cluster 104 (and therefore, for a corresponding VM HA domain) is managed by the nodes 110 of the cluster 104, instead of being managed by the cloud-based control plane 190. Accordingly, in accordance with example implementations, VM HA is maintained, even if the cloud-based control plane 190 is, for some reason, temporarily unavailable.

For purposes of managing VM HA, the nodes 110 include respective background programs called “VM HA daemons 140.” As described herein, the VM HA daemons 140 manage VM HA using a distributed key-value store. The distributed key-value store is stored across multiple nodes 110 of the cluster 104; and each of these nodes 110 has a consistent replica 132 of the distributed key-value store. The distributed key-value store is maintained by a cluster of distributed key-value store agents 142. Depending on the particular implementation, the distributed key-value store may be distributed across all of the nodes 110 of the cluster 104, or alternatively, the distributed key-value store may be distributed across less than all of the nodes 110 of the cluster 104. In the following discussion, it is assumed that the key-store is distributed across all of the nodes 110, and accordingly, each node 110 has a corresponding distributed key-value store agent 142 and a corresponding distributed key-value store replica 132. In an example, the distributed key-value store may be an etcd store. In other examples, the distributed key-value store may be a CONSUL store, a REDIS store, a MONGODB or any other distributed key-value store that provides consistent replicas of the store on the nodes 110.

The management of the VM HA, in accordance with example implementations, involves the VM HA daemons 140 coordinating to assign “leader” and “follower” HA management roles to the daemons 140. The VM HA daemons 140 perform functions commensurate with their respective assigned roles. More specifically, in accordance with example implementations, the VM HA daemons 140 of a cluster 104 elect one of the member daemons 140 to be a VM HA management “leader.” The corresponding node 110 hosting the leader VM HA daemon 140 is referred to herein as the “leader node 110.” The remaining member VM HA daemons 140 of the cluster 104 are followers, and the respective nodes 110 are referred to herein as “follower nodes 110.” In an example, the VM HA daemons 140 may elect a leader using a distributed consensus protocol, such as the RAFT protocol. A reelection may be initiated for any of a number of different reasons. In an example, a reelection may be initiated due to a preset election term expiring. In another example, a reelection may occur due to a leader VM HA daemon 140 becoming unavailable. In another example, a follower VM HA daemon 140 may lose communication with the leader VM HA daemon 140 and initiate a reelection in response thereto. In another example, a reelection may occur due to nodes 110 being added to or removed from the cluster 104.

The leader VM HA daemon 140 monitors, or watches, the distributed key-value store for purposes of detecting when any node 110 of the cluster 104 becomes unavailable. In an example, the leader VM HA daemon 140 may monitor, or watch, its distributed key-value store for purposes of detecting the disappearance of time-limited health keys that correspond to respective nodes 110. The detection of time-limited health key disappearances is referred to herein as distributed key-value store-based heartbeat monitoring. In this manner, the follower VM HA daemons 140 are supposed to renew the health key leases for their respective nodes 110 in accordance with heartbeat renewal periods, assuming that the respective nodes 110 are available. Node failure is indicated by the corresponding health key lease not being renewed, and the corresponding node health key-value entry disappearing from the distributed key-value store. The leader VM HA daemon 140 may detect node failure in an alternative way using storage-based heartbeat monitoring, as further described herein. Regardless of how node failure is detected, in response to detecting node unavailability, the leader VM HA daemon 140 determines, from VM topology keys of the distributed key-value store, the affected VMs 114 that were hosted by the unavailable node 110. Moreover, the leader VM HA daemon 140 selects one or multiple surviving nodes 110 to which the affected VMs 114 are relocated.

For purposes of relocating an affected VM (also referred to as a “relocated VM”) to a selected surviving node 110, the leader VM HA daemon 140 writes a task submission key-value entry to the distributed key-value store. The task submission key-value identifies the selected surviving node 110 and contains a value that represents a node-level task for the node 110 to create the relocated VM on the node 110. The entry of the task key-value in the distributed key-value store triggers the follower VM HA daemon 140 on the surviving node 110 to create the VM and rewrite a VM topology key for the VM 114 to the distributed key-value store. The rewritten topology key represents the new node location of the relocated VM 114.

In accordance with example implementations, a VM HA daemon 140 accesses the distributed key-value store using its associated distributed key-value store agent 142. The member distributed key-value store agents 142 coordinate to elect a leader that brokers changes to the distributed key-value store, and the remaining distributed key-value store agents 142 are followers. Therefore, a given distributed key-value store agent 142 may either operate in a leader role or operate in a follower role. In the following discussion, a distributed key-value store agent 142 operating in a leader role is referred to as the “leader distributed key-value store agent,” and a distributed key-value store agent 142 operating in a follower role is referred to as a “follower distributed key-value store agent.” In accordance with example implementations, any distributed key-value store agent 142 (whether operating in the leader or follower role) may read from the distributed key-value store. For purposes of a follower distributed key-value store agent writing an entry to the distributed key-value store, the follower distributed key-value store agent first submits the write (the proposed change) to the leader distributed key-value store agent. The leader distributed key-value store agent appends the written key-value entry to a write ahead log. The leader distributed key-value store agent then notifies the follower distributed key-value store agents about the change. The follower distributed key-value store agents then append the written key-value entry into their respective local write ahead logs and notify the leader distributed key-value store agent about the recording of the key-value entry. The leader distributed key-value store agent then waits for confirmation of the recording of the key-value entry by a quorum of the agents 142. When the leader distributed key-value store agent receives confirmation that at least a quorum of the agents 142 have recorded the key-value entry, then the leader distributed key-value store agent commits the key-value entry to its associated distributed key-value store replica 132. The leader distributed key-value store agent then then notifies the follower distributed key-value store agents to the commitment of the key-value entry, and in responsive to receiving the notification from the leader distributed key-value store agent, the follower distributed key-value store agent commit the key-value to their respective replicas 132.

The distributed key-value store agents 142 may elect a leader using a distributed consensus protocol, such as the RAFT protocol. A reelection may be initiated for any of a number of different reasons. In an example, a reelection may be initiated due to the expiration of a preset election term. In another example, an election may be initiated due to a distributed key-value store agent becoming unavailable. In another example, a follower distributed key-value store agent may initiate a reelection due to the follower distributed key-value store agent losing communication with a leader distributed key-value store agent.

The VM HA daemons 140 therefore have respective roles, and the distributed key-value store agents 142 have respective roles. In accordance with some implementations, the roles of the VM HA daemons 140 are not aligned with the roles of the distributed key-value store agents 142, and the process for electing the VM HA daemon leader is independent from the process for electing the leader agent 142. Accordingly, a given node 110 may have a VM HA daemon 140 that is a leader and a distributed key-value store agent 142 that is a follower, or vice versa. In another example, in accordance with further implementations, the roles are aligned on each node 110. In this manner, in accordance with example implementations, the VM HA daemon 140 and the distributed key-value store agent 142 for a given node 110 are either both leaders or both followers.

In accordance with example implementations, the distributed key-value store has a flat key space in that there is no intrinsic hierarchy among the keys. Stated differently, in accordance with example implementations, a given key of the distributed key-value store cannot be a descendent of another key of the distributed key-value store, or vice versa. The nomenclature used for the keys, however, allows the benefits of a hierarchical system to be achieved using the flat key space. In accordance with example implementations, the nomenclature uses key name prefixes to define relationships among the keys.

More specifically, in accordance with example implementations, the entries of the distributed key-value store are associated with respective objects and represent information about the associated objects. The objects correspond to components of the cluster system 100. In examples, the objects may correspond to clusters, networks, nodes, storage units, and VMs. In examples, the information for a given object may be related to an alias, an event, a health status, a definition, task or a topology for the given object. In accordance with example implementations, an object and the information category for the object corresponds to a full key name. A part of a key name less than the full key name is referred to as a “prefix.” Information categories and subcategories within a key name are separated by a delimiters, such the forward slash (“/”) delimiter. In the following description, identifiers for objects, such as UUIDs, are designated by braces (e.g., “{UUID}”). In an example, a UUID may correspond to a fixed length (e.g., 128 bits) sequence of bits.

As a more specific example of a key-value entry of the distributed key-value store, a definition for a VM 114 may be represented in the distributed key-value store by a key-value entry (i.e., a VM definition entry) that has the following object definition key:
/namespace/obj/vms/{vm-uuid}
   In this notation, “namespace” is an identifier for the key name space, “obj” denotes an object definition, “vms” denotes that the object definition is for a VM 114, and “vm-uuid” is the UUID of the VM 114. The key-value entry has a value that represents the VM definition. In an example, the value may be a JSON serialized structure. Because VM definitions are stored in the distributed key-value store, any node 110 may access a VM definition from its distributed key-value store replica 132.

In another example, the node location of a particular VM 114 may be represented in the distributed key-value store by the following VM topology key:
/namespace/topology/vms/{cluster-uuid}/{node-uuid}/{vm-uuid}
   For this key, “topology” denotes a topology location, “vms” denotes that the topology location is for a VM, “cluster-uuid” represents the UUID of the cluster, “node-uuid” represents the UUID of the node, and “vm-uuid” represents the UUID of the VM. The topology key itself represents the location of the VM, and as such, a topology entry of the distributed key-value store does not have a value.

In accordance with example implementations, when the leader VM HA daemon 140 detects that a node 110 is unavailable, the leader VM HA daemon 140 identifies all VMs 114 that were hosted by the failed node 110 by searching the distributed key-value store for the prefix “/namespace/topology/vms/{cluster-uuid}/{node-uuid}.” This search returns the topology keys corresponding to respective VMs 114 that were hosted by the unavailable node 110.

When a VM 114 is relocated and recreated on a surviving node 110, the corresponding VM topology key is rewritten so that the distributed key-value store properly indicates the new node location of the VM. In accordance with example implementations, the VM HA daemon 140 of the surviving node 110 rewrites the VM topology key. In an example, rewriting the topology key includes erasing, or deleting, the existing topology key for the VM 114 (which represented that the VM was hosted on the failed node 110) from the distributed key-value store and writing a new topology key for the VM 114 to the distributed key-value store (to represent that the VM 114 is now hosted by the surviving node 110).

In another example of a key-value entry of the distributed key-value store, a node level task submission may be represented in the distributed key-value store by a key-value entry that has the following key:
/namespace/tasks/submissions/nodes/{node-uuid}/{task-uuid}
   For this key, “tasks” is an identifier for the key name space, “submissions” denotes the task submission, “nodes” denotes that the object definition is for a node, “node-uuid” is the UUID of the node and “task-uuid” is the UUID of the task. The task key-value entry has a value (e.g., a JSON representation) that represents the task. A VM HA daemon 140 may identify all pending tasks for its node 110 by searching the distributed key-value store using the prefix “/namespace/tasks/submissions/nodes/{node-uuid}”. This search returns the task keys corresponding to respective pending tasks for the node 110. In a similar fashion, using the same prefix, a VM HA daemon 140 may monitor, or watch, the distributed key-value store for tasks.

In accordance with example implementations, tasks are asynchronously processed by the nodes 110. Upon a particular task being completed by a node 110, the VM HA daemon 140 of the node 110 writes a task completion key-value to the distributed key-value store replica 132. This key-value has the following key:
/namespace/tasks/completions/nodes/{cluster-uuid}/{task-uuid}
   In this notation, “completions” denotes a task completion.

In accordance with example implementations, the leader VM HA daemon 140 may detect unavailability of a follower node 110 by detecting when a health key-value corresponding to the follower node 110 disappears from the distributed key-value store. More specifically, a node 110, when functioning properly, may (via its VM HA daemon 140) renew a lease of the associated node health key. In an example, a corresponding health key for a node 110 may be the following:
/namespace/health/nodes/{node-uuid}
   In this notation, “health” denotes health status information, “nodes” denotes the health status being associated with a node, and “node-uuid” is the identifier for the node. The health key is part of a key-value entry, and in an example, the value may be a JSON serialized structure that represents health attributes of the node 110.

Among the other features of the node 110, hardware 150 of the node 110 may include one or multiple hardware processors 154 and a memory 158. In examples, a hardware processor 154 may include one or multiple central processing unit (CPU) cores and/or one or multiple graphics processing unit (GPU) cores. In another example, a hardware processor 154 may include one or multiple semiconductor CPU packages (or “sockets”).

The memory 158 includes non-transitory storage media that may be formed from semiconductor storage devices, memristor-based storage devices, magnetic storage devices, phase change memory devices, a combination of devices of one or more of these storage technologies, and so forth. The memory 158 may represent a collection of memories of both volatile memory devices and non-volatile memory devices. The memory 158 store machine-readable instructions 162 and data. In an example, data (e.g., a file) representing the distributed key-value store replica 132 may be stored in the memory 158. The memory 158 may store data related to states, data structures, programming variables, objects, libraries, files or other information.

In an example, one or multiple hardware processors 154 may execute machine-readable instructions, such as machine-readable instructions 162 that are stored in the memory 158, for purposes of providing one or multiple software components of the node 110. In examples, the software components may include the VMs 114, a main operating system, the hypervisor 124, executable components of the VM management toolkit 128, the distributed key-value store agent 142 and the VM HA daemon 140. In accordance with further implementations, a hardware processor 154 may be a hardware circuit that does not execute machine-executable instructions, such as an application specific integrated circuit (ASIC), field programmable gate array (FPGA), programmable logic device, a programmable logic device (PLD), or other hardware dedicated to providing one or multiple functions for the node 110.

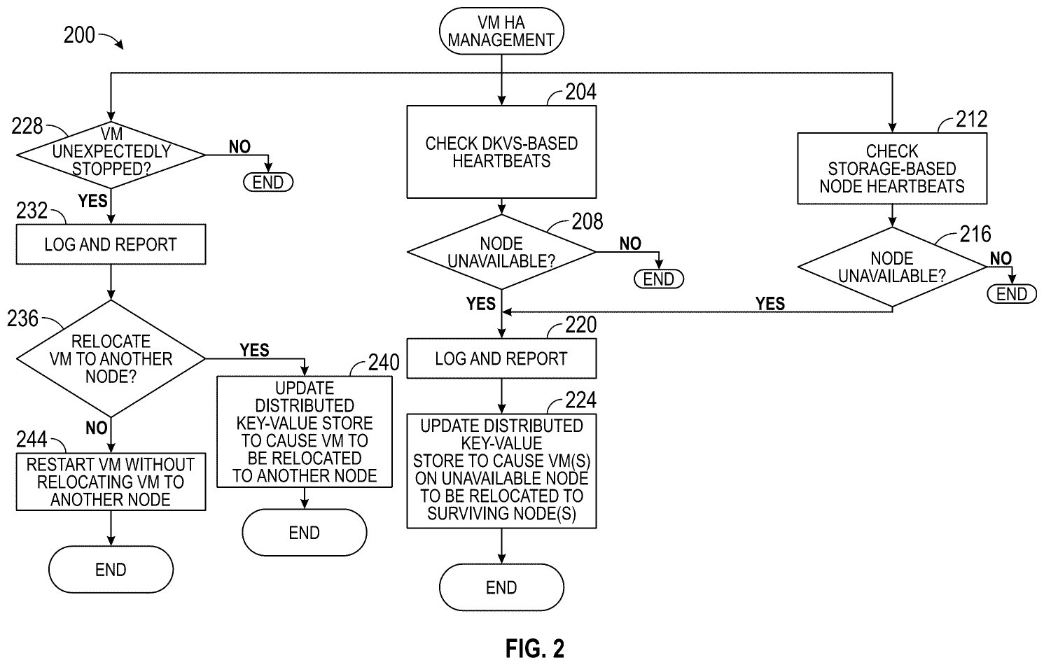

FIG. 2 is an illustration of a technique 200 illustrating VM HA management, in accordance with example implementations. Referring to FIG. 2, in an example, the technique 200 includes the use of three general VM availability detection paths, corresponding to blocks 204, 212 and 228.

Blocks 204 and 212, in accordance with example implementations, correspond to different ways for a leader VM HA daemon to detect that a particular node of the cluster is unavailable. Pursuant to block 204, the leader VM HA daemon checks distributed key-value store-based (or “DKVS-based”) heartbeats for purposes of monitoring node availability. In an example, the leader VM HA daemon may, via submission of a watch command to the distributed key-value store, receive a notification when any node health key disappears from the distributed key-value store. In an example, a particular node may have an associated health key of “/namespace/health/nodes/{node-uuid}”. The “/namespace/health/nodes/{node-uuid}” key has an associated value that represents various aspects of a particular node's health. In an example, a lease may be assigned to the “/namespace/health/nodes/{node-uuid}” key so that the key has a built-in expiration, which means that the distributed key-value store deletes the “/namespace/health/nodes/{node-uuid}” key if the lease is not renewed before the expiration. In accordance with example implementations, each VM HA daemon periodically renews its corresponding node health key according to a periodic heartbeat schedule (e.g., a schedule in which the heartbeat period is less than the lease period).

If the leader VM HA daemon determines that a particular node health key has disappeared from the distributed key-value store, then the leader VM HA daemon deems the node unavailable. Pursuant to decision block 208, pursuant to determining that a node is unavailable, control proceeds to block 220 to address the node failure, as further described below.

Pursuant to block 212, the leader HA daemon may monitor storage-based node heartbeats for purposes of detecting node unavailability. In an example, the leader VM HA daemon may checks a particular volume (e.g., a volume of a storage array, such as the storage array 168 of FIG. 1) for purposes of determining whether a node has failed. In an example, the VM HA daemon of each node may write heartbeat entries to the volume pursuant to a particular heartbeat interval. As such, the volume contains, for a node that has not failed, a sequence of heartbeat entries that have corresponding timestamps that comply with expected heartbeat intervals. If, however, a particular VM AH daemon fails to write a heartbeat entry within the expected heartbeat interval, then the absence of the entry indicates that the node is unavailable. The technique 200 includes, pursuant to determining in decision block 216 that a node is unavailable, proceeding to block 220, which is further discussed below.

The use of both the distributed key-value store-based heartbeat monitoring (corresponding to blocks 204 and 208) and storage-based heartbeat monitoring (corresponding to blocks 212 and 216) provides information regarding whether specific network communication paths for a particular node has failed. For example, a particular network failure may prevent a particular node from either renewing a node health key lease or writing heartbeat entries to the designated storage volume, but the failure may not interrupt both types of heartbeats. Consequentially, one heartbeat mechanism may indicate node unavailability, whereas the other heartbeat mechanism does not. In an example and as depicted in FIG. 2, the technique 200 deems a node failure to have occurred in response to either mechanism indicating node unavailability. Even though a node may not have failed, a node deemed unavailable by either mechanism may not have access to all of its resources due to a partial network failure. In an example of an alternative policy, the leader VM HA daemon may deem a particular node to be unavailable when both failure mechanisms indicate node unavailability, and the leader VM HA daemon may deem the node to have not failed otherwise.

If a node becomes unavailable, then multiple VMs may be affected, as the node may have hosted these VMs. After logging and reporting the node unavailability, as depicted in block 220, the leader VM HA daemon identifies the VMs hosted by the node and updates the distributed key-value store (e.g., writes task submission keys to create the VMs on one or multiple other node(s)), as depicted in block 224, to relocate the VMs.

A VM may be unavailable on a particular node that is still available. In this manner, a particular VM may unexpectedly stop on an available node. In this context, a VM unexpectedly stopping refers to the VM stopping or crashing without a command being provided to stop the VM (e.g., a VM stopped without a user of the VM powering off the VM). In accordance with example implementations, each VM HA daemon monitors the statuses of the VMs hosted on its node for purposes of determining whether any of the VMs have unexpectedly stopped. In accordance with example implementations, if a determination is made, pursuant to decision block 228, that a VM has unexpectedly stopped, then, pursuant to block 232, the unexpected stoppage is logged and reported. In an example, the unexpectedly stopped VM may be restarted on the node. Determining whether or not to restart the VM on the node may involve applying a particular VM HA policy (e.g., a policy specifies that the particular VM is always restarted or the policy specifies that the particular VM is restarted a set number of times).

In another variation, in accordance with some implementations, the leader VM HA daemon may detect unexpected VM stoppage on any node of the cluster via the distributed key-value store, and the leader VM HA daemon may use the distributed key-value store to relocate the VM to another node. More specifically, pursuant to block 236, the leader VM HA daemon determines, pursuant to decision block 236, whether the unexpectedly stopped VM should be relocated to another node. This determination may be based on a variety of different factors. In an example, the leader VM HA daemon may have a policy to relocate unexpectedly stopped VMs to other nodes. Such a policy may assume, for example, that resource contention or other problems for the VM are associated with the current node hosting the VM and relocating the VM may address these problems. In another example, the leader VM HA daemon may consider one or multiple factors for determining whether or not to relocate the VM. For example, the leader VM HA daemon may make this determination based on the number of times the particular VM has failed within a certain time period. In another example, the leader VM HA daemon may make the determination based on a time rate at which VMs for the particular node have unexpectedly stopped. In another example, the leader VM HA daemon may make the determination based on a resource utilization (e.g., processor utilization, network utilization or memory utilization) of the particular node. In another example, the leader VM HA daemon may make the determination based on a priority that has been assigned to the VM, such as, for example, whether the VM has been assigned a priority level tantamount to a mission critical application.

If, pursuant to decision block 236, the leader VM HA daemon determines that the failed VM is not to be relocated to another node, then, pursuant to block 244, the leader VM HA daemon restarts the VM on its current node, without relocating the VM to another node. Otherwise, pursuant to block 240, the leader VM HA daemon updates the distributed key-value store (e.g., writes a task submission entry) to cause the failed VM to be relocated to another node, as described herein.

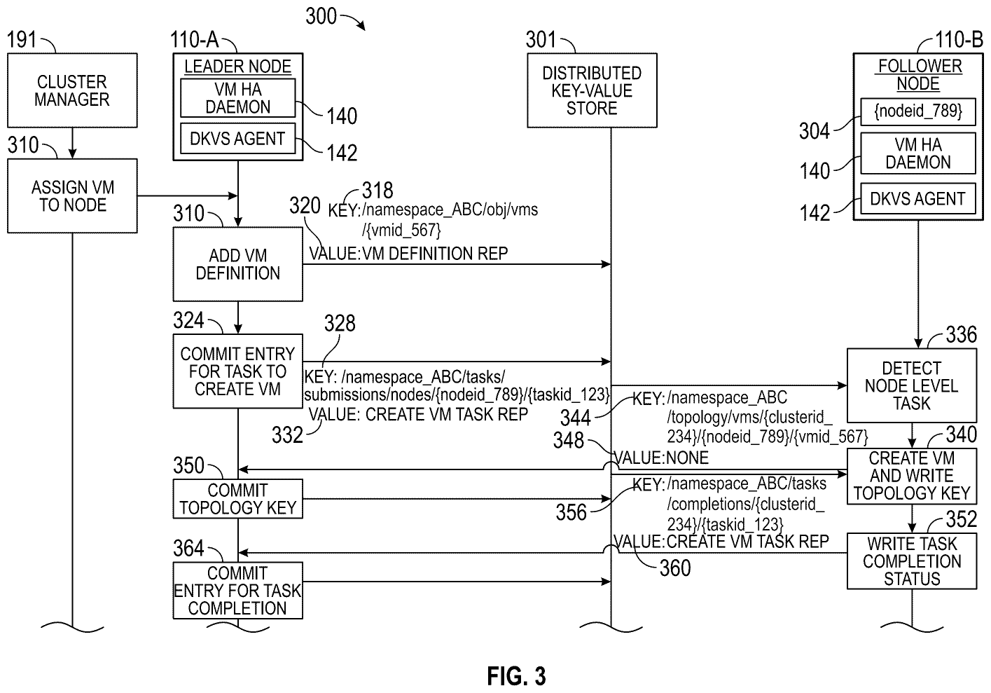

FIG. 3 is a sequence flow diagram 300 illustrating the addition of a VM to a particular node 110-B of the cluster using a distributed key-value store 301. It is assumed for purposes of this example that a node 110-A includes an VM HA daemon 140 that has been elected leader, and it is further assumed for this example that the node 110-A has a distributed key-value store agent 142 that has been elected leader. Moreover, for this example, it is assumed that the node 110-B has a node identifier of “nodeid_789”, as depicted at 304, and it is further assumed for this example that the cluster has a corresponding identifier of “clusterid_234”.

The creation of a VM on the node 110-B begins with a cluster manager 191 assigning the VM to the node 110-B, as depicted at 310. In an example, the cluster manager 191 may apply one or multiple allocation policies for purposes of selecting the node 110-B. Moreover, assigning the VM, in accordance with example implementations, includes the cluster manager 191 providing a definition of the VM. In an example, data representing the assignment directive and the VM definition may be provided, for example, via an API call to the leader VM HA daemon 140. In response to the assignment, the leader VM HA daemon 140 of the node 110-A adds the VM definition to the distributed key-value store 301. In this manner, the leader VM HA daemon 140 brokers the commitment of a VM definition key-value entry to the distributed key-value store 301. As depicted in FIG. 3, the VM definition key-value entry includes a “/namespace_ABC/obj/vms/{vmid_567}” key 318 and an associated value 320. The key 318 contains an identifier (vmid_567) for the VM being added. In an example, the value 320 is a JSON serialized structure, which represents the definition for the VM.

In the context that is used herein, a “virtual machine definition” refers to a collection of data representing attributes, or characteristics, of a virtual machine. In an example, the characteristics include configuration settings for the virtual machine. In an example, the characteristics includes resources for the virtual machine. In an example, the characteristics includes an allocation of resources for the virtual machine. In an example, the virtual machine definition includes data representing a specific guest operating system (e.g., a LINUX operating system) for the virtual machine. In an example, the virtual machine definition includes data representing a number of small computer system interface (SCSI) controllers for the virtual machine. In an example, the virtual machine definition includes data representing a number of drives (e.g., SCSI drives and/or Integrated Drive Electronics (IDE) drives) for the virtual machine. In another example, the virtual machine definition includes data representing a number of CPU cores for the virtual machine. In another example, the virtual machine definition includes data representing a number of GPU cores for the virtual machine. In another example, the virtual machine definition includes data representing a memory size for the virtual machine. In another example, the virtual machine definition includes data representing a network configuration for the virtual machine. In another example, the virtual machine definition includes data representing a storage configuration for the virtual machine. In another example, the virtual machine definition includes data representing a virtual machine version number.

As depicted at 324, the leader VM HA daemon 140 of the node 110-A commits a node-level task submission to the distributed key-value store 301 to create the VM. As depicted at 328 and 332, committing the task submission to create the VM includes the leader VM HA daemon 140 brokering a write of a task submission key-value entry to the distributed key-value store 301. In this example, the key 328 is the following:
/namespace_ABC/tasks/submissions/nodes/{nodeid_789}/{task_id_123}
   Here, “nodeid_789” corresponds to the identifier 304 for the node 110-B, and “task_id_123” represents a specific task number. Moreover, the prefix “/namespace_ABC/tasks/submissions/nodes” corresponds to a node-level task for the node 110-B (corresponding to the node identifier “nodeid_789”). The value 332 may be, for example, a JSON serialized structure representing the node level task to create the VM.

As depicted at 336, the follower VM HA daemon 140 of the node 110-B detects the node level task added by the leader VM HA daemon 140. Responsive to the detection of the node level task, the follower VM HA daemon 140 of the node 110-B then creates the VM on the node 110-B, as depicted at 340. Creating the VM may include the follower VM HA daemon 140 submitting a create VM command to the hypervisor of the node 110-B, with parameters describing the VM being derived from the VM definition provided by the VM definition key-value entry.

In associating with creating the VM, the follower VM HA daemon 140 of the node 110-B writes a topology key 344 to the distributed key-value store 301, which represents a node location of the VM. In an example, the topology key 344 is the following:
/namespace_ABC/topology/vms/{clusterid_234}/{nodeid_789}/{vmid_567}
   As depicted at 348, the key 344 does not have an associated value, as the key 344 exists for the sole purpose of providing a representation of the node location of the VM. As depicted at 350, the leader VM HA daemon 140 of the node 110-A brokers the writing of the topology key 344 to the distributed key-value store 301, resulting in the leader VM HA daemon 140 committing (as depicted at 350) the key 344 to the distributed key-value store 301.

Upon completing the task to create the VM, the follower VM HA daemon 140 writes an entry to the distributed key-value store 301. As depicted at 344, this entry includes a “/namespace_ABC/tasks/completions/{clusterid_234}/{taskid_123}”, key which represents that the task corresponding to the task identifier of “taskid_123” has been completed. In an example, the value 348 may be a JSON serialized structure representing the task that just completed. In accordance with example implementations, the leader VM HA daemon 140 of the brokers the write of the entry to the distributed key-value store 301. This is depicted at 364, which results in the corresponding entry containing the key 344 and the value 348 being committed by the leader VM HA daemon 140 to the distributed key-value store 301.

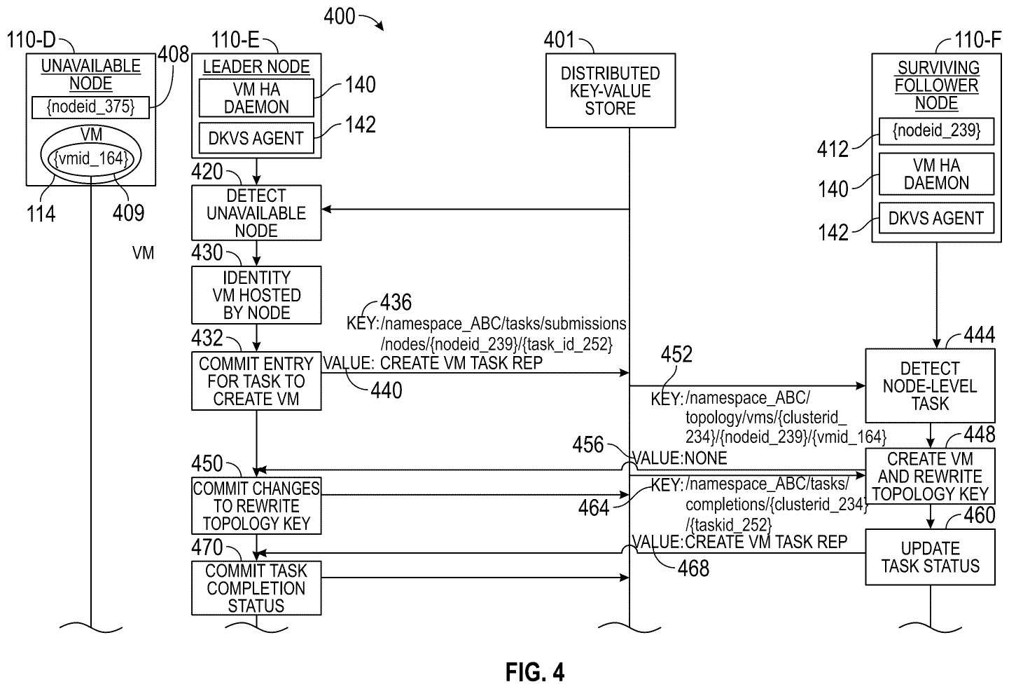

FIG. 4 depicts a sequence flow diagram 400 illustrating detection of a node 110-D becoming unavailable and the relocation of a VM 114 previously hosted by the unavailable node 110-D to a surviving node 110-F. The detection and relocation use a distributed key value store 401. The relocation is coordinated by a leader node 110-E. It is assumed for purposes of this example that the node 110-E includes a VM HA daemon 140 that has been elected leader, and it is further assumed for this example that the node 110-E has a distributed key-value store agent 142 that has been elected leader. Additionally, for this example, the unavailable node 110-D has an associated node identifier 408 of “nodeid_375”, and the VM 114 being relocated has a VM identifier 409 of “vmid_164”. Moreover, as depicted at 412, the node 110-F has a corresponding node identifier of “nodeid_239”.

The sequence 400 begins by the leader node 110-E detecting unavailability of the node 110-D, as depicted at 420. For this example, the leader VM HA daemon 140 of the leader node 110-E detects the unavailability of the node 110-D based on a missing node health key-entry in the distributed key-value store 401. Next, as depicted at 430, the leader VM HA daemon 140 of the leader node 110-E identifies the VM 114 as being hosted by the unavailable node 110-D. Although FIG. 4 depicts the leader VM HA daemon 140 identifying a single VM 114 hosted by the unavailable node 110-D for purposes of simplifying the following description, it is understood that the node 110-D may host multiple VMs, which would be relocated by the leader VM HA daemon 140 in a similar manner that is described below with respect to the VM 114. In accordance with example implementations, the leader VM HA daemon 140 of the leader node 110-E determines that the node 110-D hosted the VM 114 based on the following key (as depicted at 431) being in the distributed key-value store 401: “/namespace_ABC/topology/vms/{clusterid_234}/{nodeid_375}/{vmid_164}”

The leader VM HA daemon 140, as depicted at 432, commits a submission task (a create VM task) to the distributed key-value store 401 for purposes of causing the VM HA daemon 140 of the node 110-F to create the VM 114 on the node 110-F. For this purpose, the leader VM HA daemon 140 of the leader node 110-E writes an entry to the distributed key-value store 401. As depicted at 436, this entry includes the following key: /namespace_ABC/tasks/submissions/nodes/{nodeid_239}/{task_id_252} The key 436 identifies the node 110-F (nodeid_239). The entry includes a value 440, such as a JSON serialized structure, which represents a node-level task to create the VM 114 on the node 110-F. The leader node 110-E brokers the write, resulting in the commitment of the entry to the distributed key-value store 401.

The storing of the entry corresponding to the node level task in the distributed key-value store 401 triggers the node 110-F to create the VM 114 on the node 110-F. More specifically, as depicted at 444, the follower VM HA daemon 140 of the node 110-F detects the node-level task. Responsive to the detection of the node-level task, the follower VM HA daemon 140 of the node 110-F then creates the VM 114 on the node 110-F, as depicted at 448. The follower VM HA daemon 140 creates the VM 114 according to a definition of the VM 114 that is stored in the distributed key-value store 401. In an example, the definition may be represented by a JSON serialized structure in an entry that is identified by the following key: “/namespace_ABC/obj/vms/{vmid_164}”. Upon creating the VM, the follower VM HA daemon 140 of the node 110-F then writes an entry to the distributed key-value store 401 to record the new location of the VM 114. As depicted in FIG. 4, this value may include the following key, as depicted at 452: “/namespace_ABC/topology/vms/{clusterid_234}/{nodeid_239}/{vmid_164}”. Moreover, as depicted at 456, the entry does not contain a value. Additionally, although not depicted in FIG. 4, the follower VM HA daemon 140 may further delete the following old topology key from the distributed key-value store 401: (/namespace_ABC/topology/vms/{clusterid_234}/{nodeid_375}/{vmid_164})

As depicted at 450, the writing of the new topology key and deletion of the old topology key are brokered by the leader node 110-E, resulting in the committing of changes to the distributed key-value store 401 to write the topology key for the VM 114. The follower VM HA daemon 140 of the node 110-F next indicates completion of the node level task to add the VM 114, as depicted at 460. In an example, the follower VM HA daemon may write a task completion key-value to the distributed key-value store 401, which contains the following key 464: /namespace_ABC/tasks/completions/{clusterid_234}/{taskid_252}

The task completion key-value includes a value 468, such as a JSON serialized structure representing the node level task to create the VM. Moreover, as depicted at 470, in accordance with example implementations, the leader VM HA daemon 140 of the node 110-E brokers the writing of the task completion entry to the distributed key-value store 401, resulting in the entry being committed to the store 401.

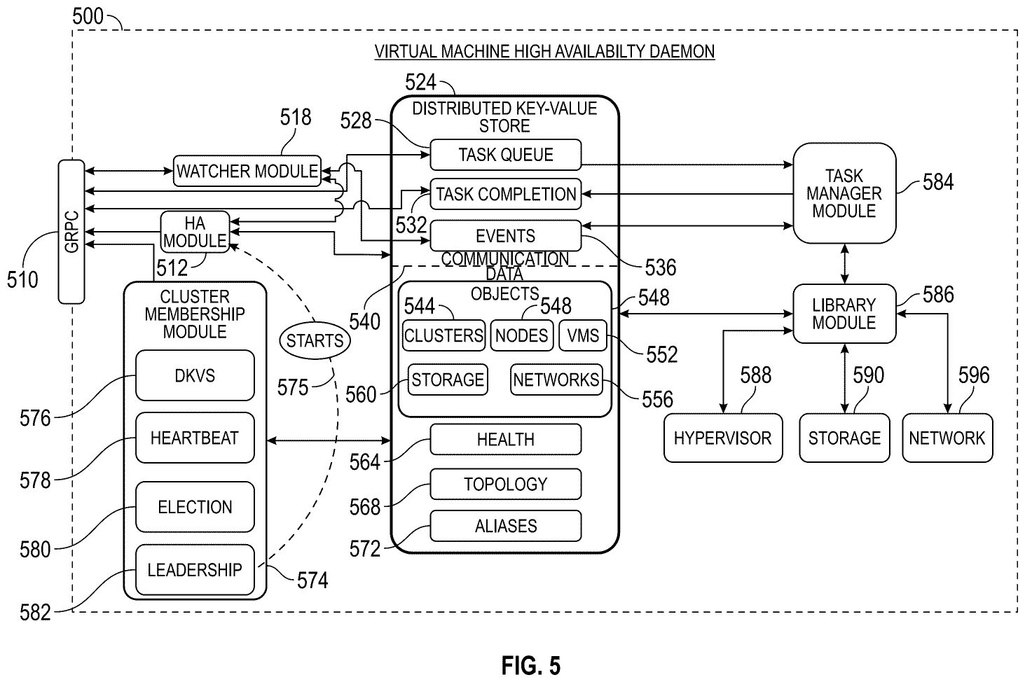

FIG. 5 is a block diagram of a VM HA daemon 500 in accordance with example implementations. In an example, the VM HA daemon 500 may correspond to the VM HA daemon 140 described above in connection with FIGS. 1, 3 and 4. In an example, the VM HA daemon 500 may correspond to machine-readable instructions (or “software”) that is executed by one or multiple hardware processors (e.g., the hardware processors 154 of FIG. 1). In an example, the VM HA daemon 500 may correspond to the Go programming language.

Referring to FIG. 5, API communications with the VM HA daemon 500, in accordance with example implementations, occur through a GRPC interface 510. In an example, the VM HA daemon 500 may communicate with other VM HA daemons via API calls and API call responses via the GRPC interface 510. The VM HA daemon 500 may be placed in one of two modes of operation: an active mode in which the VM HA daemon is a leader for VM HA; or a passive mode of operation in which the daemon 500 is a follower for VM HA.

When active, the VM HA daemon 500 detects VM unavailability of VMs of the cluster, regardless of whether the VMs are hosted on the node hosting the daemon 500 or are hosted on other nodes of the cluster. For the active mode, the VM HA daemon 500 includes an HA module 512, which is coupled to the GRPC interface 510 and monitors a distributed key-value store 524 associated with the cluster. By monitoring the distributed key-value store 524, the HA module 512 may detect VM unavailability. In an example, monitoring the distributed key-value store includes checking the distributed key-value store-affiliated node heartbeats. As a more specific example, the HA module 512 may detect, for example, when a particular node health key-value entry disappears from the distributed key-value store 524. In another example, the HA module 512 may detect a VM health key disappearing from the distributed key-value store 524. In another example, the HA module 512 may detect an event (e.g., a node stopped event) indicating VM unavailability.

Responsive to detecting VM unavailability, the HA module 512 may store one or multiple submission task key-values in the distributed key-value store 524 for purposes of initiating tasks to address the VM unavailability. In an example, these tasks may include node-level tasks to create VMs on one or multiple nodes (e.g., one or multiple follower nodes) of the cluster. These tasks may be asynchronous tasks, and the HA module 512 may monitor the distributed key-value store 524 for purposes of determining when the tasks have been completed.

When the VM HA daemon 500 is active, or a leader, the HA module 512 may further store VM definition keys in the distributed key-value store 524. The VM definition keys may be accessed by nodes of the cluster, such as, for example, when a node creates a VM for purposes of VM relocation.

For purposes of watching for changes in the distributed key-value store 524, such as, for example, events, key-value disappearances, and so forth, the HA module 512 may use a watcher module 518 of the VM HA daemon 500. In an example, the watcher module 518 may monitor the distributed key-value store 524 for purposes of detecting when node health keys and/or VM health keys disappear and correspondingly alert the HA module 512. In another example, the watcher module 518 may monitor the distributed key-value store 524 for purposes of detecting when certain events occur, such as, for example, a VM unexpectedly stopping, and for such events, the watcher module 518 may alert the HA module 512.

As depicted in FIG. 5 and demarcated by dashed line 540, the entries of the distributed key-value store 524 correspond to either communication or data. The communication-related aspects of the key-value entries refers to the entries establishing a task submission queue 528, a task completion queue 532 and an events queue 536. The task submission queue 528, task completion queue 532 and the events queue 536, as depicted in FIG. 5, may be coupled to a task manager module 584 of the VM HA daemon 500. The task manager module 584, in general, among its other functions, processes node-level tasks directed to the VM HA daemon 500 and responds to events affecting the VM HA daemon's host node. For this purpose, the task manager module 584 may, via a library module 586, communicate with hypervisor 588, storage 590 and network 596 interfaces for the host node.

The data represented by the key-value entries of the distributed key-value store 524 include data representing definitions for objects 548 of the cluster, such as cluster objects 544, node objects 548, VM objects 552, storage objects 560 and network objects 556. In addition to representing definitions for these objects 548, the key-value entries of the distributed key-value store 524 also include other information about the objects 548, such as information pertaining to health 564, topology 568 and the aliases 572.

As depicted in FIG. 5, the VM HA daemon 500 includes a cluster membership module 574. The cluster membership module 574 includes an identifier 576 for the distributed key-value store instance associated with the cluster. The cluster membership module 574 further includes a heartbeat agent 578 that provides heartbeats for the VM HA daemon 500 for purposes of indicating aliveness to other VM HA daemons of the cluster. In an example, the heartbeat agent 578 may periodically renew the lease of a health key-value entry for the associated host node to keep the key-value entry from disappearing from the distributed key-value store 524. In accordance with some implementations, the heartbeat agent 578 may further write heartbeat indicators to a particular storage volume according to a particular periodic schedule for purposes of indicating aliveness of the host node.

In accordance with some implementations, the cluster membership module 574 includes an election agent 580. The election agent 580 adheres to a distributed consensus protocol (e.g., the RAFT protocol) for purposes of communicating with the other VM HA daemons to elect a leader.

The cluster membership module 574, in accordance with example implementations, includes a leadership agent 582, which is activated in response to the VM HA daemon 500 being elected leader. As depicted at 575, when the VM HA daemon 500 is elected leader, the leadership agent 582 activates, or starts, the HA module 512.

The VM HA daemon 500 executes tasks communicated via the distributed key-value store 524 and responds to events communicated through the distributed key-value store 524, in both the passive and active modes. This allows the VM HA daemon 500, in both the passive and follower modes, to respond to tasks and events as appropriate.

Other implementations are contemplated, which are within the scope of the appended claims. For example, in accordance with further implementations, the responsibilities for the VM HA daemons may be different from those described above. For example, depending on the particular implementation, a VM definition key-entry may be stored in the distributed key-value store by either by a follower VM HA daemon or by a leader HA daemon. As another variation, depending on the particular implementation, the cluster control pane may provide a VM definition to either the follower node to which the corresponding VM is assigned or to a leader node. Depending on the particular implementation, a follower VM HA daemon may rewrite a VM topology key or a leader VM HA daemon may rewrite a VM topology key.

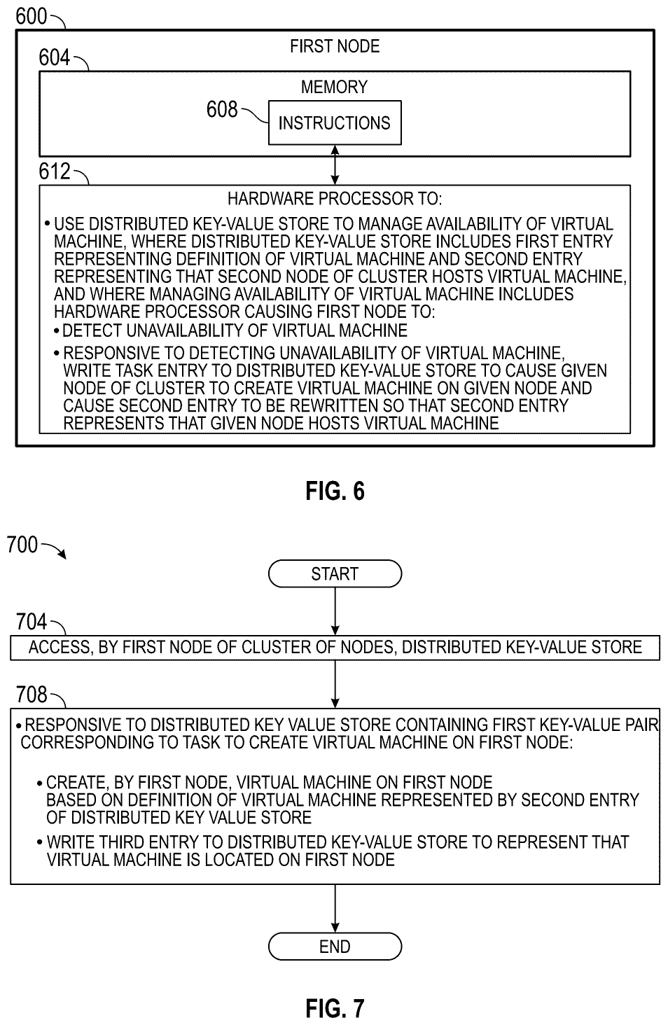

Referring to FIG. 6, in accordance with example implementations, a first node 600 of a cluster of nodes includes a hardware processor 612 and a memory 604. In an example, the hardware processor 612 may include one or multiple CPU cores. In another example, the hardware processor 612 may include one or multiple GPU cores. In another example, the hardware processor 612 may include one or multiple CPU semiconductor packages (or “sockets”). In another example, the hardware processor 612 may include one or multiple GPU semiconductor packages.

The memory 604 stores machine-readable instructions 608. The instructions 608, when executed by the hardware processor 612, cause the first node 600 to use a distributed key-value store to manage availability of a virtual machine. In an example, the distributed key-value store may be an etcd store. In an example, the instructions 608 may be associated with a daemon. In an example, the nodes may be located on-premise and a cloud-based control plane may manage the cluster. In an example, the cluster may be affiliated with an entity (e.g., a business organization), the nodes may be servers that are located on property (e.g., a private datacenter or a colocation datacenter) that is owned and controlled by the entity, and a service provider may provide the cloud-based control plane via the Internet. In an example, the cloud-based control plane orchestrates and manages the cluster. In an example, the cloud-based control plane performs node discovery and groups the nodes to form the cluster. In an example, the cloud-based control plane provisions the nodes. In an example, the cloud-based control plane scales up and down the number of nodes of the cluster to accommodate workload demand. In an example, the cloud-based control plane deploys virtual machines to the cluster. In an example, the cloud-based control plane provides definitions for the virtual machines. In an example, the cloud-based control plane provides initial node assignments for virtual machines.

The distributed key-value store includes a first entry that represents a definition of the virtual machine and a second entry that represents that a second node of the cluster hosts the virtual machine. In an example, the first entry includes a key corresponding to an identifier for the virtual machine and a value representing the definition. In an example, the value may be a JSON serialized structure representing a definition of the virtual machine. In an example, the second entry may be a topology key that represents a node location of the virtual machine. In an example, the second entry does not have an associated value.

Managing availability of the virtual machine includes the first node 600 detecting unavailability of the virtual machine. In an example, the first node 600 detects unavailability of the virtual machine by detecting whether a particular entry is absent from the distributed key-value store. In an example, the distributed key-value store may include a health key-value associated with a health of a node that hosts the virtual machine. The health key-value may be assigned a lease. The lease controls the time that the health key-value remains in the distributed key-value store, such that the expiration of the lease causes the health key-value to disappear from the distributed key-value store. In an example, the node may continually renew the lease pursuant to a heartbeat interval (e.g., a periodic heartbeat interval) for purposes of indicating that the node has not failed. In an example, detection of the absence of a node health key-value from the distributed key-value store prompts relocation of the virtual machines hosted by the node to one or multiple surviving nodes of the cluster.

In another example, the first node 600 detects unavailability of the virtual machine by monitoring storage-based heartbeats. In an example, a node may write heartbeat indicators (e.g., time-stamped indicators) to the storage volume so that if a particular heartbeat indicator is not present in the storage volume, pursuant to the heartbeat interval, then the node may be presumed to be unavailable. In an example, the first node 600 monitors health key-based heartbeats and storage-based heartbeats for a node for purposes of determining whether the node is unavailable. In an example, the first node 600 deems a particular node to be unavailable if either the health key-based heartbeat monitoring or the storage-based heartbeat monitoring indicates that the node is unavailable. In another example, the first node 600 detects unavailability of a virtual machine by monitoring distributed key-value store events, distributed key-value store health key-value entries or a combination thereof.

Managing availability of the virtual machine further includes, responsive to detecting unavailability of the virtual machine, writing a task entry to the distributed key-value store to cause a given node of the cluster to create the virtual machine on the node and cause rewriting of the second entry so that the second entry represents that the given node hosts the virtual machine. In an example, the first node 600 creates a task entry in the distributed key-value store to set forth a node-level task for the given node to create the virtual machine. In an example, creating the virtual machine includes the given node retrieving a definition of the virtual machine from the distributed key-value store. In an example, rewriting the second entry includes the given node writing an entry to the distributed key-value store representing that the virtual machine is now hosted by the given node. In an example, rewriting the second entry includes the given node writing an entry to the distributed key-value store representing that the virtual machine is hosted on the given node and deleting an entry of the distributed key-value store representing that the virtual machine is hosted by the second node that hosts the virtual machine. In another example, the first node rewrites the second entry so that the second entry represents that the given node hosts the virtual machine.

Referring to FIG. 7, in accordance with example implementations, a technique 700 includes accessing (block 704), by a first node of a cluster of nodes, a distributed key-value store. In an example, a node may be a blade server, a rack server or a tower server. In an example, the nodes may be located in one or multiple datacenters. In an example, the datacenter may be a private datacenter. In another example, the datacenter may be a colocation datacenter. In an example, the cluster may correspond to a virtual machine high availability domain. In an example, the cluster may be part of a cluster computing system that includes multiple clusters, and each cluster may correspond to a virtual machine high availability domain. In an example, the distributed key-value store may be an etcd store. In an example, the first node may be a virtual machine high availability follower selected by a virtual machine high availability leader of the cluster for purposes of relocating a virtual machine from an unavailable node to the first node.

As depicted in block 708, the technique 700 includes, responsive to the distributed key-value store containing a first entry that corresponds to a task to create a virtual machine on the first node, creating, by the first node, the virtual machine on the first node based on a definition of the virtual machine represented by a second entry of the distributed key-value store. In an example, the first entry includes a task submission key representing a node-level task submission to be processed by the first node. In an example, the first entry includes a value that represents the task to create the virtual machine. In an example, the value is a serialized representation of the task. In an example, the value is a JSON serialized representation of the task. In an example, creating the virtual machine includes executing machine-readable instructions corresponding to a daemon. In an example, creating the virtual machine includes submitting a command to a hypervisor. In an example, the hypervisor is a KVM hypervisor.

In an example, the second entry includes an object definition key that identifies the virtual machine. In an example, the second entry includes a value that corresponds to a serialized representation of the virtual machine definition. In an example, the serialized representation may be a serialized JSON representation.

In an example, the virtual machine definition is a collection of data representing attributes, or characteristics, of the virtual machine. In an example, the characteristics include configuration settings for the virtual machine. In an example, the characteristics includes resources for the virtual machine. In an example, the characteristics includes an allocation of resources for the virtual machine. In an example, the virtual machine definition includes data representing a specific guest operating system (e.g., a LINUX operating system) for the virtual machine. In an example, the virtual machine definition includes data representing a number of SCSI controllers for the virtual machine. In an example, the virtual machine definition includes data representing a number of drives (e.g., SCSI drives and/or IDE drives) for the virtual machine. In another example, the virtual machine definition includes data representing a number of CPU cores for the virtual machine. In another example, the virtual machine definition includes data representing a number of GPU cores for the virtual machine. In another example, the virtual machine definition includes data representing a memory size for the virtual machine. In another example, the virtual machine definition includes data representing a network configuration for the virtual machine. In another example, the virtual machine definition includes data representing a storage configuration for the virtual machine. In another example, the virtual machine definition includes data representing a virtual machine version number.

Also responsive to the distributed key-value store containing a first entry corresponding to the task to create the virtual machine on the first node, block 708 includes writing a third entry to the distributed key-value store to represent that the virtual machine is located on the first node. In an example, the third entry incudes a topology key representing a node location for the virtual machine. In an example, the node location corresponds to the first node. In an example, the third entry does not include a value associated with the topology key.

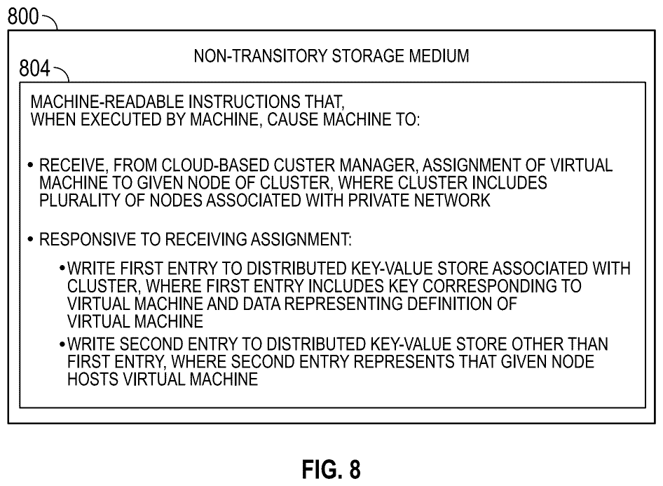

Referring to FIG. 8, a non-transitory storage medium 800 stores machine-readable instructions 804. The instructions 804, when executed by a machine, cause the machine to receive, from a cloud-based cluster manager, an assignment of a given virtual machine to a given node of a cluster. The cluster includes a plurality of nodes that are associated with a private network. In an example, the cluster corresponds to a virtual machine high availability domain. In an example, the machine may correspond to a virtual machine high availability leader of the cluster. In an example, the cloud-based cluster manager further provides a definition of the given virtual machine. In an example, the private network corresponds to on-premise components of the cluster. In an example, the cluster may be affiliated with an entity (e.g., a business organization), the nodes may be servers that are located on property (e.g., a private datacenter or a colocation datacenter) that is owned and controlled by the entity, and a service provider may provide the cloud-based control plane via the Internet. In an example, the cloud-based control plane orchestrates and manages the cluster. In an example, the cloud-based control plane performs node discovery and groups the nodes to form the cluster. In an example, the cloud-based control plane provisions the nodes. In an example, the cloud-based control plane scales up and down the number of nodes of the cluster to accommodate workload demand. In an example, the cloud-based control plane deploys virtual machines to the cluster. In an example, the cloud-based control plane provides definitions for the virtual machines. In an example, the cloud-based control plane provides initial node assignments for virtual machines.

The instructions 804, when executed by the machine, further cause the machine to, responsive to receiving the assignment, write a first entry to a distributed key-value store associated with the cluster. The first entry includes a key that corresponds to the given virtual machine and data associated with the key and representing a definition of the given virtual machine. In an example, the key includes a UUID identifying the given virtual machine. In an example, the first entry does not identify a node location of the given virtual machine. In an example, the first entry includes a value representing the definition of the given virtual machine.

In an example, the virtual machine definition includes a collection of data representing attributes, or characteristics, of the given virtual machine. In an example, the characteristics include configuration settings for the virtual machine. In an example, the characteristics includes resources for the virtual machine. In an example, the characteristics includes an allocation of resources for the virtual machine. In an example, the virtual machine definition includes data representing a specific guest operating system (e.g., a LINUX operating system) for the virtual machine. In an example, the virtual machine definition includes data representing a number of SCSI controllers for the virtual machine. In an example, the virtual machine definition includes data representing a number of drives (e.g., SCSI drives and/or IDE drives) for the virtual machine. In another example, the virtual machine definition includes data representing a number of CPU cores for the virtual machine. In another example, the virtual machine definition includes data representing a number of GPU cores for the virtual machine. In another example, the virtual machine definition includes data representing a memory size for the virtual machine. In another example, the virtual machine definition includes data representing a network configuration for the virtual machine. In another example, the virtual machine definition includes data representing a storage configuration for the virtual machine. In another example, the virtual machine definition includes data representing a virtual machine version number.

The instructions 804 further cause the machine to, responsive to receiving the assignment, write a second entry to the distributed key-value store other than the first entry. The second entry represents that the given node hosts the given virtual machine. In an example, the second entry includes a topology key. In an example, the topology key identifies the given node and identifies the given virtual machine. In an example, the second entry does not include a value associated with the topology key.

In accordance with example implementations, the instructions, when executed by the hardware processor, further cause the hardware processor to delete a first topology key of the distributed key-value store associating the virtual machine with the second node and write a second topology key to the distributed key-value store associating the virtual machine with the given node. A particular advantage is that unavailable virtual machines may be relocated to other nodes without involvement by a cloud-based cluster control plane.

In accordance with example implementations, the instructions, when executed by the hardware processor, further cause the hardware processor to detect the unavailability of the virtual machine responsive to determining that the second node has failed. A particular advantage is that unavailable virtual machines may be relocated to other nodes without involvement by a cloud-based cluster control plane.

In accordance with example implementations, the instructions, when executed by the hardware processor, further cause the hardware processor to determine that the second node has failed responsive to detecting the absence of a heartbeat key corresponding to the second node in the distributed key-value store. A particular advantage is that unavailable virtual machines may be relocated to other nodes without involvement by a cloud-based cluster control plane.

In accordance with example implementations, the instructions, when executed by the hardware processor, further cause the hardware processor to determine that the second node has failed responsive to heartbeat data stored in a storage volume and associated with the cluster. A particular advantage is that unavailable virtual machines may be relocated to other nodes without involvement by a cloud-based cluster control plane.

In accordance with example implementations, the instructions, when executed by the hardware processor, further cause the hardware processor to detect the unavailability of the virtual machine responsive to detecting absence of a heartbeat key associated with the second node in the distributed key-value store. A particular advantage is that unavailable virtual machines may be relocated to other nodes without involvement by a cloud-based cluster control plane.

In accordance with example implementations, the first entry includes a key that identifies the given node and the task; and a value that represents the task. A particular advantage is that unavailable virtual machines may be relocated to other nodes without involvement by a cloud-based cluster control plane.

In accordance with example implementations, the second entry, prior to being rewritten, includes a key that identifies the cluster, identifies the second node and identifies the virtual machine. The key, after the second entry is rewritten, identifies the cluster, the given node and the virtual machine. A particular advantage is that unavailable virtual machines may be relocated to other nodes without involvement by a cloud-based cluster control plane.

In accordance with example implementations, the key includes a prefix that represents that the key identifies a virtual machine location. The second entry does not have a value associated with the key. A particular advantage is that unavailable virtual machines may be relocated to other nodes without involvement by a cloud-based cluster control plane.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A first node of a cluster of nodes, wherein the first node comprises:
a hardware processor; and
a memory to store machine-readable instructions that, when executed by the hardware processor, cause the first node to use a distributed key-value store to manage availability of a virtual machine, wherein the distributed key-value store stores a first entry representing a definition of the virtual machine and a second entry representing that a second node of the cluster hosts the virtual machine, and wherein managing availability of the virtual machine comprises the first node to:
detect unavailability of the virtual machine; and
responsive to detecting unavailability of the virtual machine, write a task entry to the distributed key-value store to cause a given node of the cluster to create the virtual machine on the given node and cause rewriting of the second entry so that the second entry represents that the given node hosts the virtual machine.

2. The first node of claim 1, wherein the instructions, when executed by the hardware processor, further cause the first node to delete a first topology key of the distributed key-value store associating the virtual machine with the second node and write a second topology key to the distributed key-value store associating the virtual machine with the given node.

3. The first node of claim 1, wherein the instructions, when executed by the hardware processor, further cause the first node to detect the unavailability of the virtual machine responsive to determining that the second node has failed.

4. The first node of claim 3, wherein the instructions, when executed by the hardware processor, further cause the first node to determine that the second node has failed responsive to detecting the absence of a heartbeat key corresponding to the second node in the distributed key value store.

5. The first node of claim 3, wherein the instructions, when executed by the hardware processor, further cause the first node to determine that the second node has failed responsive to heartbeat data stored in a storage volume and associated with the cluster.

6. The first node of claim 1, wherein the instructions, when executed by the hardware processor, further cause the first node to detect the unavailability of the virtual machine responsive to detecting absence of a heartbeat key associated with the second node in the distributed key-value store.

7. The first node of claim 1, wherein the task entry comprises:
a key identifying the given node and the task; and
a value representing the task.

8. The first node of claim 1, wherein:
the second entry, prior to being rewritten, comprises a key identifying the cluster, identifying the second node and identifying the virtual machine; and
the key, after the second entry is rewritten, identifies the cluster, the given node and the virtual machine.

9. The first node of claim 8, wherein:
the key comprises a prefix representing the key identifies a virtual machine location; and
the second entry does not have a value associated with the key.

10. A method comprising:
accessing, by a first node of a cluster of nodes, a distributed key-value store; and
responsive to the distributed key-value store containing a first entry corresponding to a task to create a virtual machine on the first node:
creating, by the first node, the virtual machine on the first node based on a definition of the virtual machine represented by a second entry of the distributed key-value store; and
writing a third entry to the distributed key-value store to represent that the virtual machine is located on the first node.

11. The method of claim 10, further comprising, responsive to the distributed key-value store containing the first entry, sending, by the first node and to a leader of the cluster, a request for the leader to write the third entry to the distributed key-value store, wherein writing the third entry comprises the leader writing the third entry to the distributed key-value store.

12. The method of claim 10, further comprising, responsive to the distributed key-value store containing the first entry:
deleting a fourth entry of the distributed key-value store, wherein the fourth entry represents that the virtual machine is located on a second node of the cluster.

13. The method of claim 12, further comprising, responsive to the distributed key-value store containing the first entry, sending, by the first node and to a leader of the cluster, a request for the leader to delete the fourth entry from the distributed key-value store, wherein deleting the fourth entry comprises the leader deleting the fourth entry from the distributed key-value store.

14. The method of claim 10, wherein:
the first entry comprises a key identifying the task, and the key comprises a prefix designating the key as a task submission and identifying the first node.

15. The method of claim 10, further comprising:
writing a fourth entry to the distributed key-value store to represent completion of the task.

16. A non-transitory storage medium that stores machine-readable instructions that, when executed by a machine, cause the machine to:
receive, from a cloud-based cluster manager, an assignment of a given virtual machine to a given node of a cluster, wherein the cluster comprises a plurality of nodes associated with a private network; and
responsive to receiving the assignment:
write a first entry to a distributed key-value store associated with the cluster, wherein the first entry comprising a key corresponding to the given virtual machine and data associated with the key and representing a definition of the given virtual machine; and
write a second entry to the distributed key-value store other than the first entry, wherein the second entry represents that the given node hosts the given virtual machine.

17. The storage medium of claim 16, wherein:
the instructions are associated with a virtual machine high availability daemon;
the machine is associated with a second node of the cluster;
the second node hosts a plurality of virtual machines;
the distributed key-value store comprises third entries defining respective virtual machines of the plurality of virtual machines and fourth entries representing that the second host hosts the plurality of virtual machines; and
the instructions, when executed by the machine, further cause the machine to manage the plurality of virtual machines.

18. The storage medium of claim 16, wherein, the instructions when executed by the machine further cause the machine to, responsive to a failure of the given node:
select a replacement node of the cluster to host the given virtual machine; and
write a third entry to the distributed key-value store representing a task to be performed by the replacement node to create the given virtual machine on the replacement node.

19. The storage medium of claim 18, wherein the third entry comprises:
a key comprising a name corresponding to a task identifier and comprising a prefix designating the third entry as a task submission and identifying the replacement node; and
a value corresponding to a serialized representation of the task.

20. The storage medium of claim 18, wherein the second entry comprises:
a key comprising a name corresponding to a virtual machine identifier and comprising a prefix designating the second entry as representing a topology, identifying the cluster and identifying the given node.
